(19) United States
(12) Patent Application Publication
(10) Pub. No.: US 2006/0098437 A1
(43) Pub. Date: May 11, 2006

(54) Rechargeable halogen search light

(76) Inventor: Se Kit Yuen, Hong Kong (HK)

Correspondence Address: ARTHUR KING MA, 1030 CORONADO DRIVE, ARCADIA, CA, 91007, US

(21) Appl. No.: 10/983,869

(22) Filed: Nov. 8, 2004

(51) Int. Cl. F21V 21/14; F21V 29/00

(52) U.S. Cl. 362/287; 362/183; 362/399; 362/373

(57) ABSTRACT

The present invention is relates to a rechargeable halogen search light and more particularly, to a rechargeable halogen search light having two supporting legs and an adjustable handle providing a mean of third supporting leg. Said supporting legs may move relatively and interactively between position one and position two. If said supporting legs are adjusted to an angle over 90°, user may place said light in any position within 90 degree. Said supporting stands can also provide an adjustable mean with a tight or loose positions so as to controlling such supporting legs in a locked position or in a rotating position to reach the best lighting range and lighting angles through said attached hinge to any position within 270 degrees circular ark. The present invention is an important source of light used in marine, army, public security, firefighting, emergency treatment, disciplined troop, architecture and civil vessels, as well as emergency treatment in daily life.

### BACKGROUND OF PRESENT INVENTION

1. Field of Invention

The present invention is relates to a rechargeable halogen search light and more particularly, to a rechargeable halogen search light which is having an ability to light up 1.5 km radius with a handle and three supporting legs. Said three supporting legs may move relatively and interactively between position one and position two. If all said supporting legs are adjusted to an angle over 90°, user may place said light in any position within 90 degree.

2. Description of Related Arts

Military, law enforcement, fire and rescue personnel, security personnel, hunters and recreational boaters among others for nighttime surveillance in any application commonly use handheld halogen searchlights, where a high intensity spotlight is required. Nowadays, such application is highly demeaned in all anti-terrorists actions that take place at nighttime. Conditions of use are highly varied, but generally require the light to deliver a desired field of view at long distances, be reliable, durable and field maintainable in order for it to be practically used in the designed applications. Typically the light is hand carried and must be completely operable using simple and easily access manual controls, which do not require the use of two hands. In prior art xenon short-arc searchlights or illumination systems, whether handheld, portable or fixed mounted, the luminance distribution of the arc has been positioned facing in the direction of the beam (cathode to the rear), to provide a uniform beam pattern when the arc is at the focal point of the parabolic reflector. When the arc is moved slightly beyond (or slightly rearward of) the reflector's focal point, the combination of a placing all available light in the high magnification section of the reflector and collecting it in a slightly convergent manner produces roughly twice the operating range as a conventional anode-forward device.

Also, all prior arts of lanterns are focusing mainly of power sources or power supply to power up lanterns. Seldom of prior arts are aiming to improve lighting angles as most lanterns are used with handheld or placed on a table/floor or even placed with a hat. However, it is very obviously that lantern with an ability to rotate with certain degree of angles s so needed.

U.S. Pat. No. 6,685,337 provides a lanterns which combine both a flashlight with a candle together to ensure said lantern can still light up when power source is done or batteries are all used up. However, the lighting range, lighting angles and the lighting power of a candle are minimal. Such lantern light up by a candle will not be the most useful tool in an event of a big area.

U.S. Pat. No. 6,629,767 discloses a lantern with a batteries compartment with shock absorber lining to protect batteries contained therein from damage due to excessive shock applied to said batteries. Again, this lantern is only aiming a power supply to said lantern but lighting range and lighting angle are being ignored.

U.S. Pat. No. 6,702,452 provides a lantern with a tripod supporting legs. The mounting is a tripod mount so that the portable searchlight may be fixed in the field to a tripod with the second device. The mounting on the handle is a thumbscrew mount to permit mounting of an optical detection device onto the searchlight and rigidly fixed to the housing. However, this lantern provide without no ability to move any angle to obtain a better light range.

### SUMMARY OF PRESENT INVENTION

The main object of the present invention is to provide a rechargeable halogen search light having a supporting means and such supporting means comprise of 2 supporting legs and an adjustable handle which can provide an ability to rotate an angle more than 90 degree so as to provide support for user to place said light in any position within 90 degree.

Another object of the present invention is to provide a rechargeable halogen search light having a supporting means and such supporting mean can provide an ability to rotate and/or to move any position within 90 degree circular arc.

Another object of the present invention is to provide a rechargeable halogen search light having an ability to adopt difference power source supplies.

Another object of the present invention is to provide a rechargeable halogen search light having a supporting means and such supporting mean can provide an adjustable mean with a tight or loose positions so as to controlling such supporting legs in a locked position or in a rotating position to reach the best lighting range and lighting angles.

Accordingly, to achieve the above objects, a rechargeable halogen search light comprises:

a rectangular housing, inside of it contains a mean of lighting source;

a plurality of reflector is fixed around said mean of light source; and

a transparent front flat board;

a sealed packing collar is connecting a inner portion of said transparent front flat board and said reflector which resides inside of an annular nut, said annular nut providing a fixed position and a disassembled position on front portion of said housing. Surface of said annular nut, which is located in front of said housing, set an annular shockproof nut. It is made of rubber or other soft material to prevent said rechargeable halogen lantern from shocks or quakes when excessive external force applied to it.

### BRIEF DESCRIPTION OF SAID DRAWINGS

FIG. 1 is a right side view of the present invention.

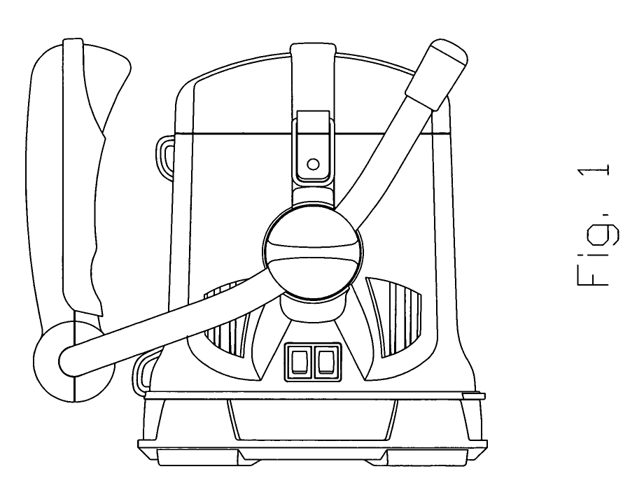

FIG. 2 is a left side view thereof.

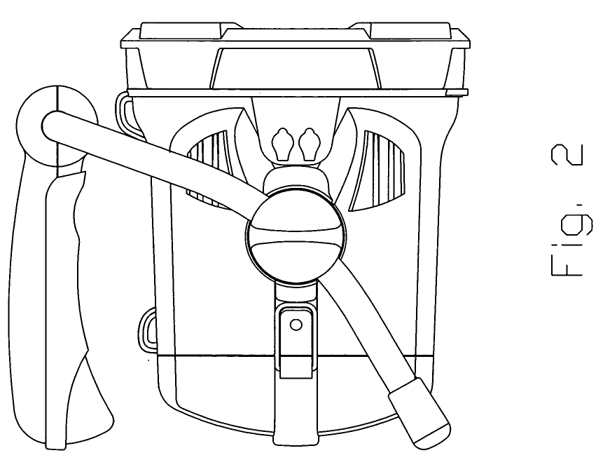

FIG. 3 is a front view thereof.

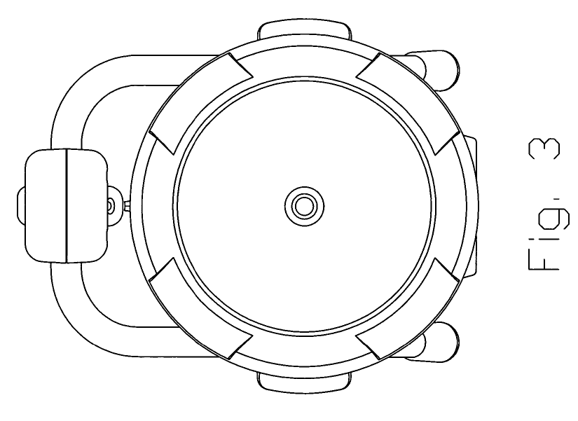

FIG. 4 is rear view thereof.

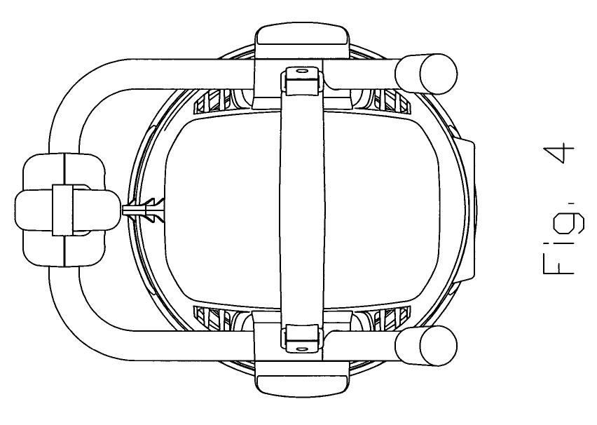

FIG. 5 is a top view thereof.

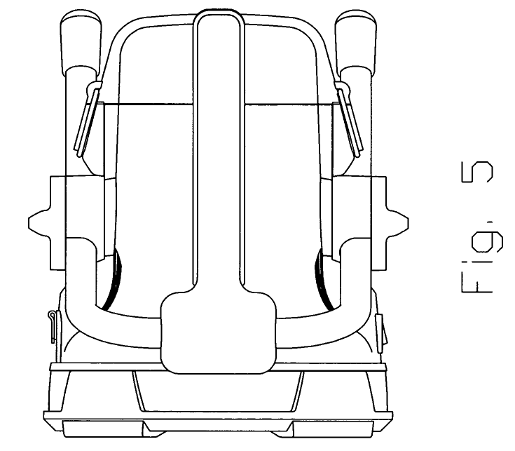

FIG. 6 is a bottom view thereof.

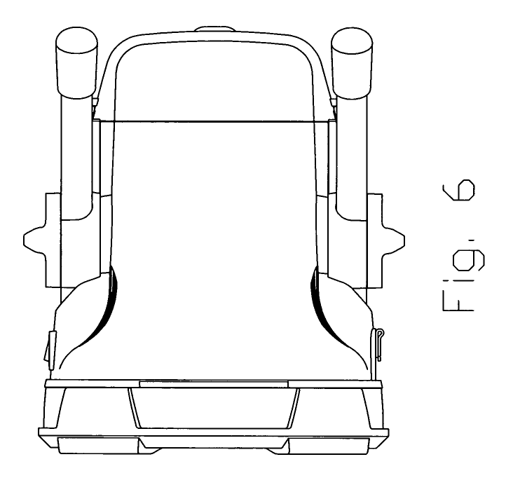

FIG. 7 is an isometric right side view thereof.

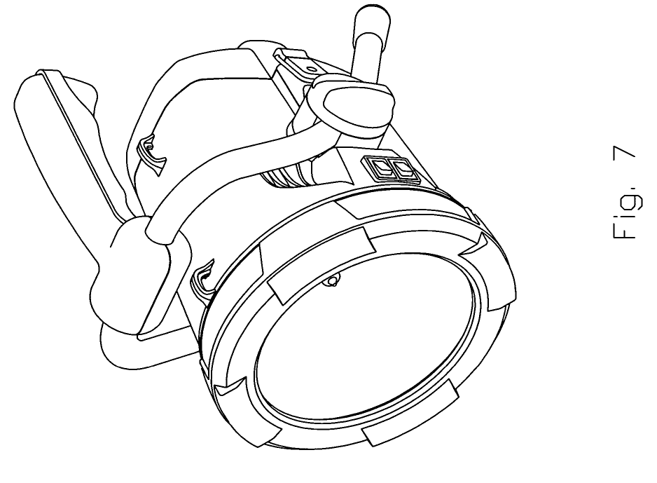

FIG. 8 is an isometric left rear view with a third support leg in an opening position thereof.

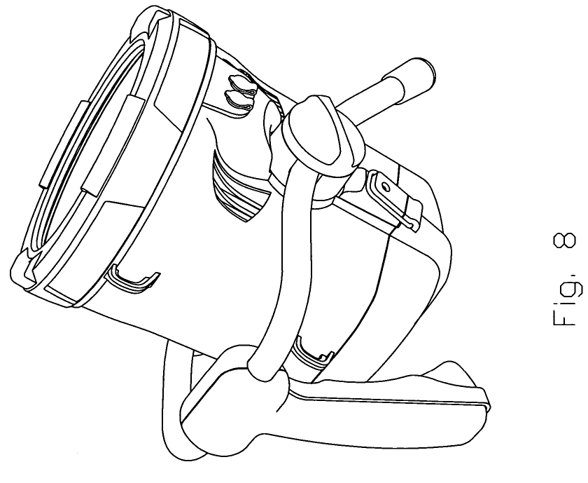

FIG. 9 is an isometric left rear view with a third support leg in closing position thereof.

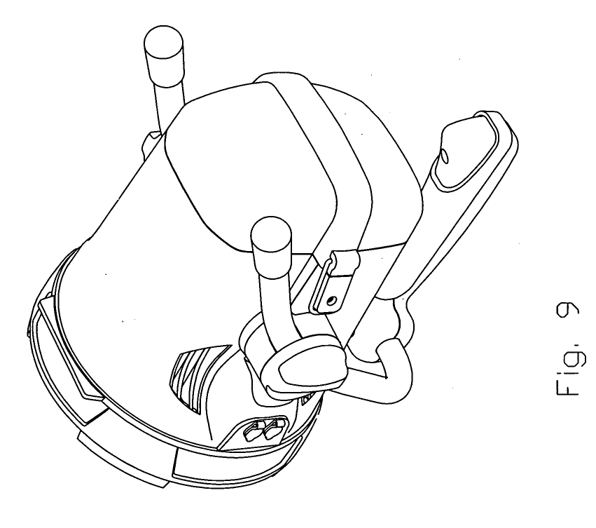

FIG. 10 is an isometric right front side view with a third support leg in an opening position thereof.

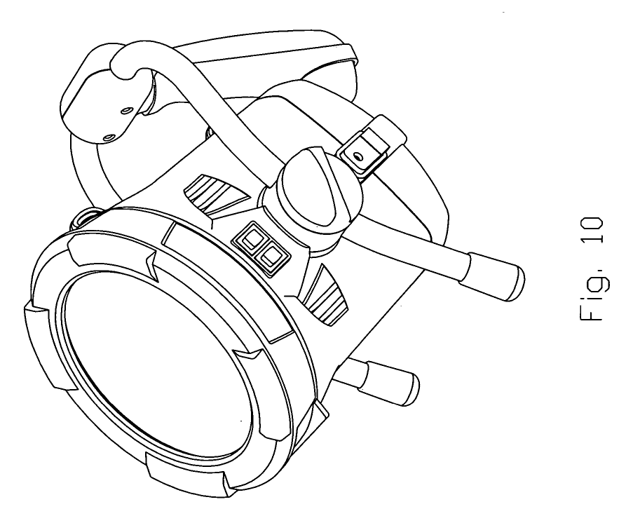

FIG. 11 is a sectional view thereof.

FIG. 12 is an assembly view thereof.

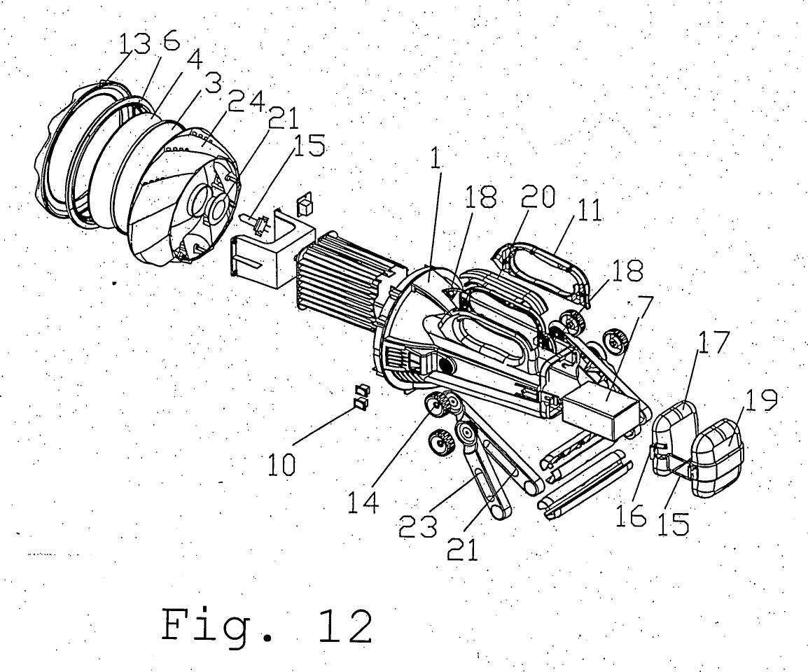

### DETAILED DESCRIPTION OF SAID PREFERRED EMBODIMENT

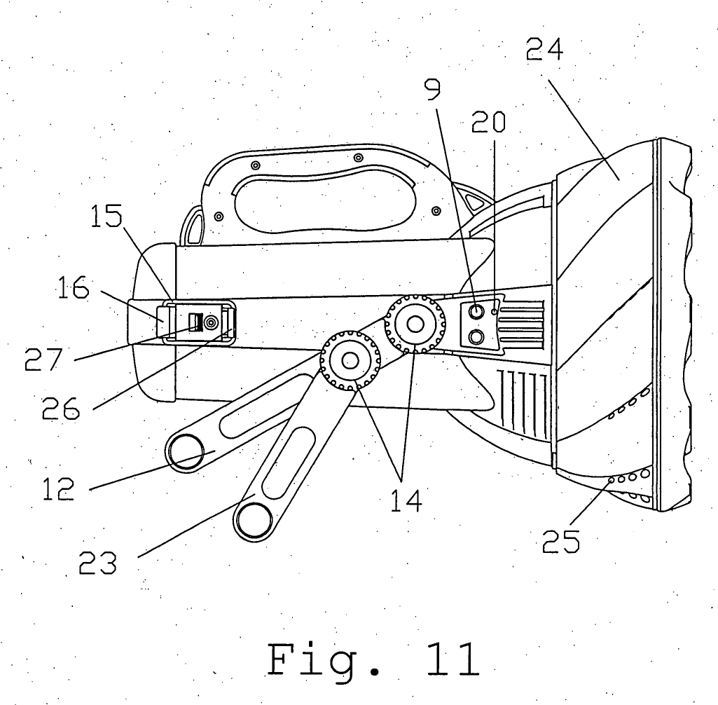

Referring FIG. 11, this rechargeable halogen search light comprises an illuminant (1) usually in a shape of a rectangular cylinder. At the front portion of said illuminant (1) there is a circular shape detachable heat-release cover (24), there are many heat-lease holes (25) along with said detachable heat-release cover (24). Inside said illuminant (1), there is a light source (2), a reflector (3) generally in a shape of a parabola, and a front panel (4) usually made of glass or other transparent materials. By a sealing washer (5), said front panel (4) is sealed to end portion of said reflector (3) within a front annular head (6) from inside. Said annular head (6) is fastened to a front end of said detachable heat-release cover (24) in a dismantling manner. On the surface of said annular head (6) in front of said illuminant (1), there is an annular lightening protection head (13) made of rubber or flexible material that enables a photoelectric source searchlight to absorb the shock from outside.

As illustrated in figures, said light source (2) consists of an energy-saving halogen bulb (15), which is fastened to a base (21) and is powered by the built-in power source (7) of said illuminant. A power connects to an electric circuit device (8) inside said illuminant (1), an external socket (9), a switch (10) and said connected energy-saving light bulb (15) through a power line. Along the underneath portion of said handle (11), which is also a third supporting leg, there is a padding (22) made of resilient material to provide comfort when holding this search light. At both ends of said handle (11), there are two latches provided for a detachable belt.

An adjustable supporting leg (12) is mounted with said illuminant (1). There is an adjustable control (14) provides locking and unlock positions for said supporting leg (12). Said supporting leg (12) is pivot around a hinge and remain at any position within the 270° arc, so as to provide a support for said illuminant (1) on a plant surface to achieve a optimal lighting angle. Another adjusted supporting leg (23), is flexibly attached to said supporting leg (22) and can tightened up with an adjustable latch (14) to fasten said supporting leg (23). Said supporting leg (23) is pivot around a hinge and remain at any position within the 270° arc, so as to provide a support for said illuminant (1) on a plant surface to achieve an optimal lighting angle.

There is a flexibly connected battery cover (17) at a back portion of said illuminant (1). Said battery cover (17) is fastened to a flange (16) on back of portion of said illuminant (1) by a metal screw (15). Said metal screw (15) provides a locking mean to a lockable piece (26) located at the end portion of said illuminant (1). By pushing a release latch (27) of said lockable piece (26), said metal screw (15) thereby detach from locking piece (26) and release said battery cover (17), (21), at rear end of said illuminant (1), there is a sealed with a front surface of said battery cover (17) from inside. Said battery cover (17) is fastened to rear end portion of said illuminant (1) in a dismantling manner. After separating said battery cover (17) from said illuminant (1), user can replace batteries therein. There is a sealing head (19) made of resilient materials on top surface of said battery cover (17). Said sealing head (19) is attached to a shield (20), which seals all possible entrance to said external socket (9) to provide protection against damage and intrusion of rain or water.

Said invention, rechargeable compact fluorescent floodlight has adjustable supporting leg (22) and supporting leg (23) at its bottom. It allows user to apply said search light without holding it by hand and yet needs sufficient lighting by putting said search light on a supporting surface such as a table or ground.

This rechargeable halogen search light is an important source of lighting mean employed in marine, army, public security, firefighters, emergency treatments, disciplined troops, architecture and civil vessels, as well as for emergency treatment in daily life.

What is claimed is:

1. A rechargeable halogen search light comprises:
a rectangular housing, inside of it contains a mean of lighting source;
a plurality of reflector is fixed around said mean of light source; and
a plurality of transparent front flat board; and
a plurality of seal packing collar is connecting an inner portion of said transparent front flat board and said reflector which resides inside of a plurality of annular nut. Said plurality of annular nut providing a fixed position and a disassembled position on front portion of said housing. Surface of said annular nut, which is located in front of said housing, set of plurality of annular shockproof nut. It is made of rubber or other soft material to prevent said rechargeable halogen lantern from shocks or quakes when excessive external force applied to it; and
having a supporting means and such supporting mean can provide an adjustable mean with a tight or loose positions so as to controlling such supporting legs in a locked position or in a rotating position to reach the best lighting range and lighting angles; and
having two supporting legs and an adjustable handle providing a mean of third supporting leg between position one and position two allowing tightly affixed at any position to provide an adjustable lighting angle, said supporting legs provide a support on plane surface for to provide a distance lighting mean with any angle over 90°, and
said supporting legs can also provide rotating positions through said adjustable hinge to any position within 270 degrees circular arc. They provide support for said housing in a horizontal position to get the best lighting angle, and having a handle attached to said housing providing mean of carrying.

2. A rechargeable halogen search light comprises:
a rectangular housing, inside of it contains a mean of lighting source;
a plurality of reflector is fixed around said mean of light source; and
a plurality of transparent front flat board; and
a plurality of seal packing collar is connecting an inner portion of said transparent front flat board and said reflector which resides inside of a plurality of annular nut. Said plurality of annular nut providing a fixed position and a disassembled position on front portion of said housing. Surface of said annular nut, which is located in front of said housing, set of plurality of annular shockproof nut. It is made of rubber or other soft material to prevent said rechargeable halogen lantern from shocks or quakes when excessive external force applied to it; and
having a supporting means which is having two supporting legs and an adjustable handle providing a mean of third supporting leg and such supporting mean can provide an adjustable mean with a tight or loose positions so as to controlling such supporting legs in a locked position or in a rotating position to reach the best lighting range and lighting angles; and
having a supporting leg which can move relatively and interactively between position one and position two allowing tightly affixed at any position to provide an adjustable lighting angle, said supporting legs provide a support on plane surface for to provide a distance lighting mean with any angle over 90°, and
said supporting leg can also provide rotating positions through said adjustable hinge to any position within 270 degrees circular arc, and
having a supporting leg which can move relatively and interactively between position one and position two allowing tightly affixed at any position to provide an adjustable lighting angle, said supporting legs provide a support on plane surface for to provide a distance lighting mean with any angle over 90°, and
said supporting leg can also provide rotating positions through said adjustable hinge to any position within 270 degrees circular arc,
They provide support for said housing in a horizontal position to get the best lighting angle, and
having a handle attached to said housing providing mean of carrying.

3. A rechargeable halogen search light as recited in claim 1, wherein, said rechargeable halogen search light is further comprises:
at least one light bulb,
at least one arc shaped reflector,
at least one set of main switch,
at least one power receptacle for external electricity,
at least one transformer, and
at least one set of circuitry and power supply.

4. A rechargeable halogen search light as recited in claim 1, wherein supporting leg is having two supporting legs and an adjustable handle providing a mean of third supporting leg and said supporting leg can provide an adjustable mean with a tight or loose positions so as to controlling such supporting legs in a locked position or in a rotating position to reach the best lighting range and lighting angles through said attached hinge to any position within 270 degrees circular ark. Said stands can move relatively and interactively between position one and position two allowing tightly affixed at any position to provide an adjustable lighting angle, said supporting legs provide a support on plane surface for to provide a distance lighting mean with any angle over 90°, Said stands provide supports for said housing.

5. A rechargeable halogen search light as recited in claim 1, wherein said rechargeable halogen search light is a light, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light
housing by said user manipulation;
and a fluted heat sink mounted on said light housing, wherein said housing conductively dissipates lamp heat from said anode.

6. A rechargeable halogen search light as recited in claim 1, wherein said rechargeable halogen search light comprises a lighting source, has an energy saving halogen light bulb, which is located on a light base. Electricity is provided by a power source within said housing. Electricity current goes through power cord to the insides of electrical circuitry of said housing and transformer, while connects power receptacle, on/off switch, and links up with energy saving florescent bulb.

7. A rechargeable halogen search light as recited in claim 1, wherein said rechargeable halogen search light can draw electricity either from AC power outlet provided from public utility or from the chargeable battery directly.

8. A rechargeable halogen search light as recited in claim 1, wherein said rechargeable halogen search light further comprises:
a handle in a rectangular shape is longitudinally attached to said housing. A front and rear of the handle are equipped with stripes so as to provide a mean of carrying.

9. A rechargeable halogen search light as recited in claim 1, wherein said rechargeable halogen search light further comprises:
a battery cover is located at rear portion of said housing. Metal screws tightly locked a battery cover to the rear bump of said housing. A seal packing collar fastens the light fixture's rear inside with a front end of said battery cover. Said battery cover provides disassembling position or a fixed position at rear portion of said housing. Batteries can be changed when said battery cover and said housing are separated. Surface of said battery cover contains a rubber or soft material made sealing nut. There is a lid on said sealing nut that can seal the entrance of said external receptacle, thus prevent water and is more durable.

10. A rechargeable halogen search light as recited in claim 2, wherein said stands can provide an adjustable mean with a tight or loose positions so as to controlling such supporting legs in a locked position or in a rotating position to reach the best lighting range and lighting angles through said attached hinge to any position within 270 degrees circular ark. Said supporting legs can move relatively and interactively between position one and position two allowing tightly affixed at any position to provide an adjustable lighting angle, said supporting legs provide a support on plane surface for to provide a distance lighting mean with any angle over 90°, Said stands provide supports for said housing.

11. A rechargeable halogen search light as recited in claim 2, wherein said rechargeable halogen search light is a light, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light
housing by said user manipulation;
and a fluted heat sink mounted on said light housing, wherein said housing conductively dissipates lamp heat from said anode.

12. A rechargeable halogen search light as recited in claim 2, wherein said rechargeable halogen search light comprises a lighting source, has an energy saving halogen light bulb, which is located on a light base. Electricity is provided by a power source within said housing. Electricity current goes through power cord to the insides of electrical circuitry of said housing and transformer, while connects power receptacle, on/off switch, and links up with energy saving halogen bulb.

13. A rechargeable halogen search light as recited in claim 2, wherein rechargeable halogen search light t can draw electricity either from AC power outlet provided from public utility or from the chargeable battery directly.

14. A rechargeable halogen search light as recited in claim 1, wherein said rechargeable halogen search light t further comprises:
a handle in a rectangular shape is longitudinally attached to said housing. A front and rear of the handle are equipped with stripes so as to provide a mean of carrying.

15. A rechargeable halogen search light as recited in claim 1, wherein said rechargeable halogen search light further comprises:
a battery cover is located at rear portion of said housing. Metal screws tightly locked a battery cover to the rear bump of said housing. A seal-packing collar fastens the light fixture's rear inside with a front end of said battery cover. Said battery cover provides disassembling position or a fixed position at rear portion of said housing. Batteries can be changed when said battery cover and said housing are separated. Surface of said battery cover contains a rubber or soft material made sealing nut. There is a lid on said sealing nut that can seal the entrance of said external receptacle, thus prevent water and is more durable.
